(19) United States
(12) Patent Application Publication
(10) Pub. No.: US 2012/0108110 A1
(43) Pub. Date: May 3, 2012

(54) ELECTRICAL CONNECTOR

(75) Inventor: KE LI, Shenzhen (CN)

(73) Assignee: HON HAI PRECISION INDUSTRY CO., LTD., New Taipei (TW)

(21) Appl. No.: 13/218,456

(22) Filed: Aug. 26, 2011

(30) Foreign Application Priority Data
Nov. 1, 2010 (CN) 201020587052.0

(51) Int. Cl. H01R 24/00

(52) U.S. Cl. 439/660

(57) ABSTRACT

An electrical connector includes an insulating housing defining a mounting surface and several contacts received in the housing. The contacts include soldering tails abutting against the mounting surface. The insulating housing has air holes running through the mounting surface to align with the corresponding soldering tails.

### BACKGROUND OF THE INVENTION

1. Field of the Invention

The present invention relates to an electrical connector, and more particularly to an electrical connector with a high quality of soldering.

2. Description of Related Art

Electrical card connectors are usually mounted on PCBs of the electronic devices to establish data transmission between the cards and the electronic devices. An electrical connector comprises a connector body, a metallic shell covering above the connector body, a supporting member moveably assembled into the connector body, and a terminal module. The connector body includes a pair of side walls commonly defining a receiving space in which the terminal module is received. The terminal module includes a plurality of contacts and a body for retaining the contacts. Each contact includes a soldering tail, a bend portion and a horizontal portion disposed between the soldering tail and the bend portion. The solder portion is welded to external device by SMT (Surface Mounted Technology). Nevertheless, it may bring blisters in the solder when welding.

Hence, an electrical card connector with a high quality of soldering quality is desired.

### BRIEF SUMMARY OF THE INVENTION

Accordingly, an object of the present invention is to provide an electrical card connector with a better soldering quality of contacts.

To achieve the above object, an electrical connector comprises an insulating housing defining a mounting surface and several contacts received in the housing. The contacts comprise soldering tails abutting against the mounting surface. The insulating housing has air holes running through the mounting surface to align with the corresponding soldering tails.

Other objects, advantages and novel features of the invention will become more apparent from the following detailed description when taken in conjunction with the accompanying drawings.

### BRIEF DESCRIPTION OF THE DRAWINGS

FIG. 1 is an exploded view of an electrical card connector in accordance with a preferred embodiment of the present invention;

FIG. 2 is an assembled view of the electrical card connector as shown in FIG. 1;

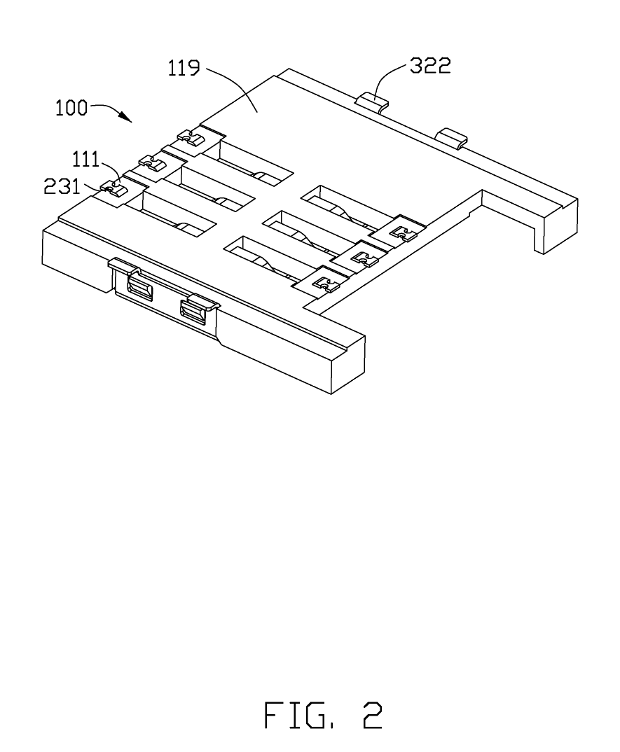

FIG. 3 is another assembled view of the electrical card connector as shown in FIG. 1;

FIG. 4 is a cross sectional view of the electrical card connector as shown in FIG. 1.

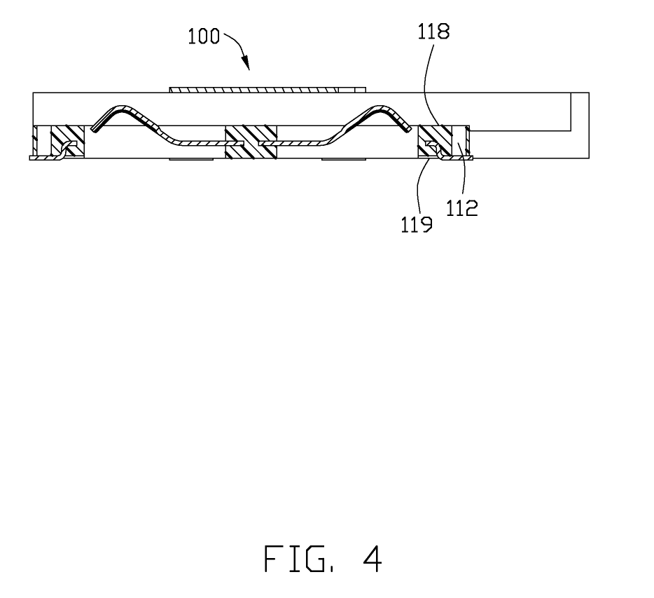

### DETAILED DESCRIPTION OF THE PREFERRED EMBODIMENTS

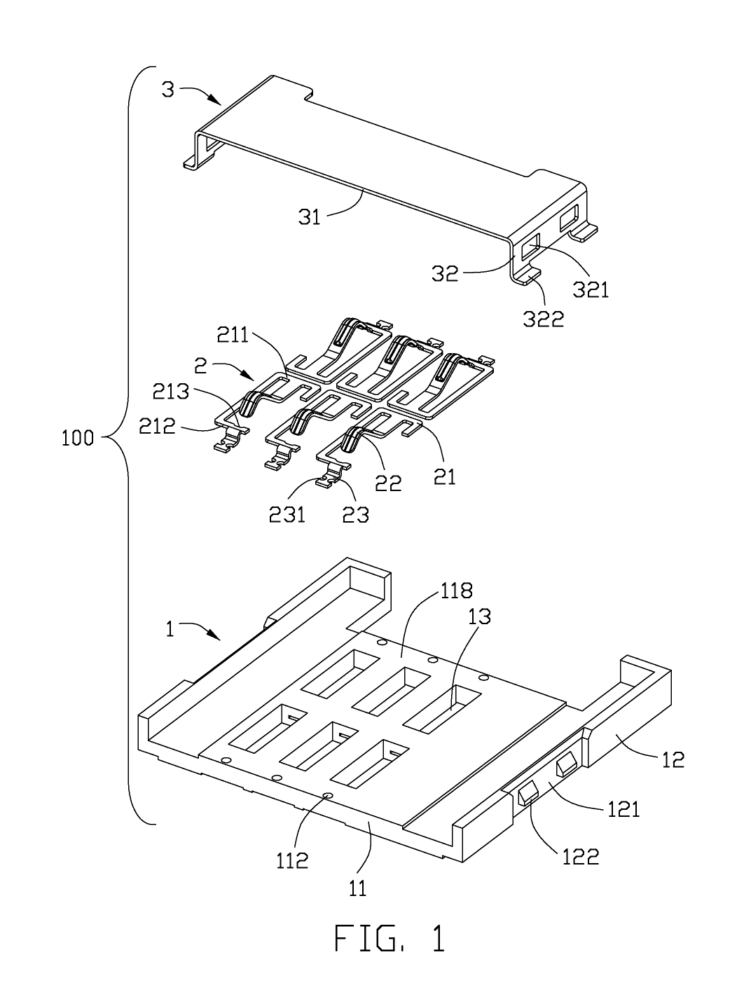

Reference will now be made to the drawing figures to describe the preferred embodiment of the present invention in details. FIGS. 1˜3 illustrates an electrical card connector 100 for insertion of a card (unshown). The electrical card connector 100 includes an insulating housing 1, a plurality of contacts 2 retained in the insulating housing for data transmission and a metal cover 3 shielding the insulating housing. The metal cover 3 is attached to the insulating housing 1 to define a card receiving space for receiving the card.

The insulating housing 1 includes a base portion 11 and a pair of opposite side walls 12 extending vertically from the corresponding edges of the base portion 11. The base portion 11 defines a mating face (the upper face) 118 and a mounting face 119 (the bottom face). The mating face confronts with the inserted card. Two rows of terminal passageways 13 are disposed between the opposite side walls 12 and each terminal passageway extends parallel to the sidewall and runs through the mating and mounting face. The mounting face 119 defines several square shallow depressions 111 communicating with corresponding terminal passageways through the adjacent end face perpendicular to the mating face of the insulating housing 1.

The contacts 2 are retained in the housing 1 by injection molding, having horizontal fixed sections 21, contacting sections 22 extending in the corresponding terminal passageway and exposed to the mating face 118 and solder sections 23 flatting against the mounting face 119. Each fixed section includes a long arm 211 and a short arm 212 parallel to the long arm. The long arm 211 is configured at the center of the base portion 11, in a partition portion between said two rows of the passageways, while the short arm is disposed near the end faces of the housing. The contacting sections extend parallel to the side walls 12 from the long arms towards the short arms. The short arm 212 has a recess 213 facing the contacting section 22. The recesses 213 allow to accommodate free distal ends of the contacting section 22 when the contacts are urged to downward in the terminal passageways. The solder section 23 extends downwards from the short arm 212 to be accommodated in the shallow depressions 111 so that the solder sections are in a small plane. The solder section 23 further defines a pair of semi-circular notches 231 at both sides thereof parallel to the side walls.

The insulating housing 1 further comprises a plurality of small air holes 112 corresponding to the solder section 23. The air holes run through the mating face 118, the mounting face 119 and the shallow depressions 111. The air holes are aligned with corresponding solder sections one by one and communicate with an exterior of the insulating housing.

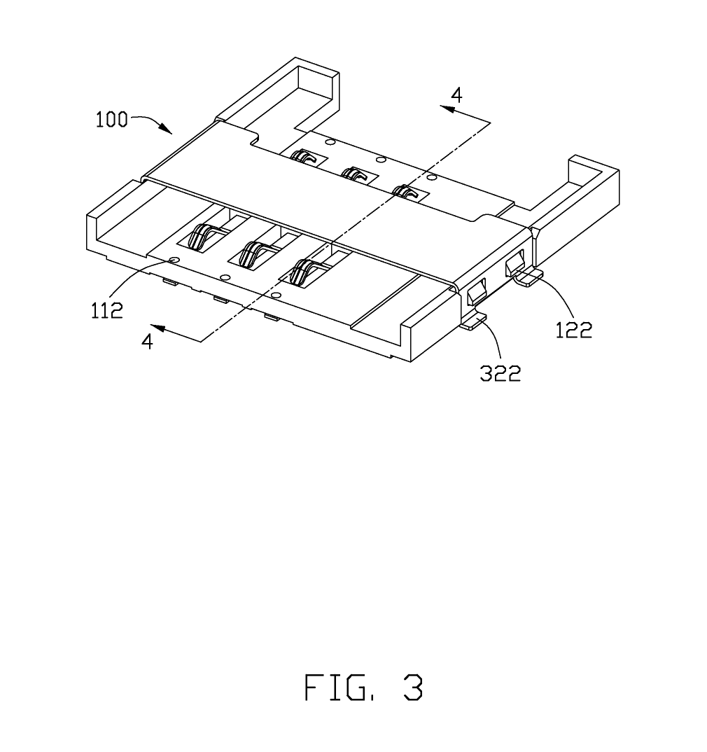

Referring to FIGS. 1 and FIGS. 3, the shell 3 includes a main part 31 and a pair of fixed parts 32 extending from both sides of the main part. Each fixed part 32 has at least two locking holes 321 for matching with the lock portions 122 set in the side wall's cave 121. The locking holes 321 are horizontally arranged. The shell extends solder tails 322 from the fixed parts. The solder tails 322 are welded to the printed circuit board (unshown).

When soldering, solder material is able to flow into the semi-circular notches 231 and surround the solder section 23, but not put the solder section up. Meanwhile, the air holes 112 are through the housing 1, so there will be no air bubbles forming in the solder material. With the notches 231 of the solder section and the air holes 112, it improves the solder quality of the contacts obviously.

What is claimed is:

1. An electrical card connector comprising:
an insulating housing defining a mounting face;
a plurality of contacts retained in the insulating housing with solder sections exposed to the mounting face;
wherein the insulating housing includes a plurality of air holes running through the mounting face and corresponding to the solder section.

2. The electrical card connector as claimed in claim 1, wherein the insulating housing further defines a mating face opposite to the mounting face and the air holes run through the mating face.

3. The electrical card connector as claimed in claim 1, wherein each solder section of the contacts defines a pair of notches on both sides thereof

4. The electrical card connector as claimed in claim 3, wherein each contact comprises a fixed section, a contacting section and said solder section, the solder section extends from the fixed section and the fixed section defines a recess facing the contacting section.

5. The electrical card connector as claimed in claim 4, further comprising a shell configured on the insulating housing, the shell comprising a pair of welding tails exposed to the mounting face.

6. The electrical card connector as claimed in claim 5, wherein said mounting face defines shallow depressions to accommodate with solder sections of the contacts.

7. An electrical card connector adapted for mounting on a circuit board , the connector comprising:
an insulating housing defining a mounting face confronting with the circuit board;
a plurality of contacts retained in the insulating housing and comprising contacting sections and solder sections flatting against the mounting face;
wherein the insulating housing defines air holes aligned with each corresponding solder section and communicate with an exterior of the insulating housing.

8. The electrical card connector as claimed in claim 7, wherein the air holes run vertically to a mounting face opposite to the mating face.

9. The electrical card connector as claimed in claim 8, wherein mounting face is depressed with shallow depressions to receive the soldering sections of the contacts so that the solder sections are in a small plane with the mounting face.

10. The electrical card connector as claimed in claim 8, wherein air holes runs through the shallow depressions.

11. An electrical card connector comprising:
an insulative housing defining opposite mating and mounting surfaces in a vertical direction;
a plurality of contacts disposed in the housing with contacting sections extending upward beyond the mating surface for mating with a counterpart, and horizontal tail sections extending below the mounting surface for mounting to a printed circuit board under condition that the horizontal tail section is essentially located within a contour of the housing so as to be protectively hidden under the housing; wherein the housing defines a plurality of through holes extending through the opposite mating and mounting surfaces and in alignment with the corresponding horizontal tail section in the vertical direction.

12. The electrical card connector as claimed in claim 11, wherein the horizontal tail section defines a hourglass configuration, and a center axis of the through hole is aligned with a narrowed waist of said hourglass configuration in the vertical direction.

13. The electrical card connector as claimed in claim 12, wherein the through hole is dimensioned to be essentially primarily comply with a size of the narrowed waist of the horizontal tail section.

14. The electrical card connector as claimed in claim 13, wherein the contacts are insert molded within the housing.

15. The electrical card connector as claimed in claim 11, wherein a thickness of the housing between the opposite mating and mounting surface is not less than five times of that of the contact.

16. The electrical card connector as claimed in claim 11, wherein the housing further defines a plurality of passageways in respective alignment with the corresponding through holes in a transverse direction perpendicular to the vertical direction, and said passageways extend through the opposite mating and mounting surfaces.

17. The electrical card connector as claimed in claim 11, wherein each of said contacts defines a retention section located at a mid-level of the housing between said opposite mating and mounting surfaces.
